(19) United States
(12) Patent Application Publication
(10) Pub. No.: US 2018/0167805 A1
(43) Pub. Date: Jun. 14, 2018

(54) TRANSMITTING PARAMETER DATA BETWEEN A TELECOMMUNICATIONS NETWORK AND A TELECOMMUNICATIONS TERMINAL AND FOR ACTIVATING AND/OR CHANGING AND/OR DEACTIVATING A COMMUNICATION PROFILE ON THE TELECOMMUNICATIONS TERMINAL, WHICH COMMUNICATION PROFILE IS DEFINED OR DENOTED BY THE PARAMETER DATA

(71) Applicant: Deutsche Telekom AG, Bonn (DE)

(72) Inventor: Marcus Perlick, Moenchengladbach (DE)

(21) Appl. No.: 15/578,744

(22) PCT Filed: Jun. 3, 2016
(86) PCT No.: PCT/EP2016/062624

§ 371 Date: Dec. 1, 2017

(30) Foreign Application Priority Data
Jun. 3, 2015 (EP) 15170545.6

(51) Int. Cl. H04W 8/20; H04W 12/08; H04W 8/24; H04W 12/04; H04L 29/08

(52) U.S. Cl. CPC H04W 8/205; H04W 12/08; H04W 88/02; H04W 12/04; H04L 67/303; H04W 8/24

(57) ABSTRACT

A method for transmitting parameter data between a telecommunication network and a telecommunication terminal and for activating and/or changing and/or deactivating a communication profile defined or denoted by the parameter data on the telecommunication terminal includes: receiving, by the telecommunication terminal, the parameter data from the telecommunication network, wherein the parameter data have an associated piece of Multipurpose Internet Mail Extensions (MIME) type information; and activating a MIME handler application of the telecommunication terminal—based on the MIME type information—such that the parameter data are used to activate and/or change and/or deactivate the communication profile in the telecommunication terminal by virtue of the MIME handler application having at least partial or at least indirect access to the eUICC module and bringing about a change and/or addition to the content of the memory area associated with the eUICC module.

### CROSS-REFERENCE TO RELATED APPLICATIONS

This application is a U.S. National Phase application under 35 U.S.C. § 371 of International Application No. PCT/EP2016/062624, filed on Jun. 3, 2016, and claims benefit to European Patent Application No. EP 15170545.6, filed on Jun. 3, 2015. The International Application was published in German on Dec. 8, 2016 as WO 2016/193414 A1 under PCT Article 21(2).

### FIELD

The invention relates to a method for transmitting parameter data between a telecommunication network and a telecommunication terminal and for activating and/or changing and/or deactivating a communication profile defined or denoted by the parameter data on the telecommunication terminal, wherein the telecommunication terminal has an eUICC module, wherein the eUICC module provides the functions of an embedded universal integrated circuit card (eUICC), wherein the eUICC module stores the parameter data at least partially or indirectly for use of the telecommunication network according to the communication profile in a memory area associated with the eUICC module.

The invention further also relates to a system for transmitting parameter data between a telecommunication network and a telecommunication terminal and for activating and/or changing and/or deactivating a communication profile defined by the parameter data on the telecommunication terminal, wherein the system comprises the telecommunication network and the telecommunication terminal, wherein the telecommunication terminal has an eUICC module, wherein the eUICC module provides the functions of an embedded universal integrated circuit card, wherein the eUICC module stores the parameter data at least partially or indirectly for use of the telecommunication network according to the communication profile in a memory area associated with the eUICC module.

In addition, the invention also relates to a telecommunication terminal for transmitting parameter data between a telecommunication network and the telecommunication terminal and for activating and/or changing and/or deactivating a communication profile defined by the parameter data on the telecommunication terminal, wherein the telecommunication terminal has an eUICC module, wherein the eUICC module provides the functions of an embedded universal integrated circuit card, wherein the eUICC module stores the parameter data at least partially or indirectly for use of the telecommunication network according to the communication profile in a memory area associated with the eUICC module.

Further, the invention also relates to a computer program having a program code and a computer program product having a computer-readable medium and a computer program stored on the computer readable medium with a program code for transmitting parameter data between a telecommunication network and a telecommunication terminal and for activating and/or changing and/or deactivating a communication profile defined by the parameter data on the telecommunication terminal.

### BACKGROUND

In a mobile radio network, subscribers are typically assigned subscriber identity information that can normally be stored as part of a subscriber identity module (SIM) in the telecommunication terminal of the subscriber. For example, subscribers in 3GPP mobile radio networks (LTE/GSM/UMTS) networks have an international mobile radio subscriber identity (IMSI, International Mobile Subscriber Identity) that identifies them in the mobile radio network of their service provider. Usually, a subscriber identity module is installed on a physical chip or a card that can normally be provided separately from a telecommunication terminal, which typically represents not inconsiderable effort.

In addition, it is likewise a generally known practice to use an embedded subscriber identity module (eSIM) with a telecommunication terminal. The use of an eSIM module in the telecommunication terminal particularly allows a higher level of customer benefit, for example in terms of convenience, cost or else in terms of time for provision of a service, to be attained.

In order to be able to usefully entrench an embedded subscriber identity module (eSIM) as a platform in the realm of the end customer market (consumer segment), the technology needs to support a multiplicity of customer processes. In particular, it is necessary to support interactive customer processes in the course of which the operator or network operator of the telecommunication network initiates operations on the embedded subscriber identity module (or eSIM operations) as provision of a service on the telecommunication terminal of a customer.

Methods involving remote function calls are known, which, however, normally require the caller of a particular operation (or what is known as the client for this operation) to be able to reach the provider of the function call (or what is known as the server for this operation) directly. If the caller (client) of a remote function call cannot reach the provider (server) directly, this is normally equivalent to the situation of Internet-compatible telecommunication terminals that are directly reachable neither via a static Internet protocol address nor via an Internet domain name and accordingly cannot be addressed from the Internet.

Besides the lack of opportunity to address a server (i.e. the telecommunication terminal), there is also the possibility of connection setup to a server being explicitly blocked by a network node, for example a firewall, between client and server.

To overcome this lack of opportunity for connection setup to the server, different “push technologies” have been developed that are based on the roles of client and server being reversed, that is to say the terminal (or the telecommunication terminal), as a client, asking the partner or network node, which now acts as a server, on the Internet whether it has an order for the terminal (or the telecommunication terminal); this process is also referred to as polling. Depending on the service, the queries from the terminal clients (telecommunication terminals) to the server (network node of a network operator of the telecommunication network) take place regularly, that is to say in time-based fashion, or on the basis of the occurrence of specific events in the terminal (telecommunication terminal).

A disadvantage in this instance, however, is that known solutions or implementations of this kind act at application level, or require installation of a particular application on the telecommunication terminal. Hence, such services or solutions do not allow a telecommunication terminal to provide a service independently of a specific application that is installed or set up therefor on the telecommunication terminal. For example, an instant messaging client thus typically registers with a specific push service in order to search for current messages thereon. However, this is normally an instant messaging client, which needs to be installed as a specific application on the telecommunication terminal or the terminal.

Such a state of a telecommunication terminal (i.e. with an installed specific application) cannot normally be presupposed for situations for transmitting parameter data for activating and/or changing and/or deactivating a communication profile on a telecommunication terminal (in order to support interactive customer processes in the course of which the operator or network operator of the telecommunication network initiates operations on the embedded subscriber identity module (or eSIM operations) as provision of a service on the telecommunication terminal), however.

### SUMMARY

In an exemplary embodiment, the present invention provides a method for transmitting parameter data between a telecommunication network and a telecommunication terminal and for activating and/or changing and/or deactivating a communication profile defined or denoted by the parameter data on the telecommunication terminal. The telecommunication terminal has an embedded universal integrated circuit card (eUICC) module, wherein the eUICC module provides the functions of an eUICC. The eUICC module is used to store the parameter data at least partially or indirectly for use of the telecommunication network according to the communication profile in a memory area associated with the eUICC module. The communication profile is associated both with a network operator of the telecommunication network and with the telecommunication terminal or a user of the telecommunication terminal. The method includes: in a first step, receiving, by the telecommunication terminal, the parameter data from the telecommunication network, wherein the parameter data have an associated piece of Multipurpose Internet Mail Extensions (MIME) type information; and in a second step, which follows the first step, activating a MIME handler application of the telecommunication terminal—based on the MIME type information—such that the parameter data are used to activate and/or change and/or deactivate the communication profile in the telecommunication terminal by virtue of the MIME handler application having at least partial or at least indirect access to the eUICC module and bringing about a change and/or addition to the content of the memory area associated with the eUICC module.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 schematically shows a communication diagram between a user of a telecommunication terminal, the telecommunication terminal and the telecommunication network according to an exemplary embodiment the invention.

FIG. 2 schematically shows a part (or a network node) of the telecommunication network and a telecommunication terminal according to an exemplary embodiment of the invention.

### DETAILED DESCRIPTION

Exemplary embodiments of the invention provide a method for transmitting parameter data between a telecommunication network and a telecommunication terminal and for activating and/or changing and/or deactivating a communication profile defined or denoted by the parameter data, which allows a higher level of customer benefit and lower costs and a time advantage to be attained for the provision and/or changing of a service or business service.

In an exemplary embodiment, the invention provides a method for transmitting parameter data between a telecommunication network and a telecommunication terminal and for activating and/or changing and/or deactivating a communication profile defined or denoted by the parameter data on the telecommunication terminal, wherein the telecommunication terminal has an eUICC module, wherein the eUICC module provides the functions of an embedded universal integrated circuit card (eUICC), wherein the eUICC module is used to store the parameter data at least partially or indirectly for use of the telecommunication network according to the communication profile in a memory area associated with the eUICC module, wherein the communication profile is associated
both with a network operator of the telecommunication network
and with the telecommunication terminal or with a user of the telecommunication terminal,
   wherein to transmit the parameter data to the telecommunication terminal and to activate and/or change and/or deactivate the communication profile in the eUICC module of the telecommunication terminal, the following steps are performed:
in a first step, the parameter data are transmitted from the telecommunication network to the telecommunication terminal, wherein the parameter data have an associated piece of MIME type information (Multipurpose Internet Mail Extensions type information),
in a second step, which follows the first step, a MIME handler application of the telecommunication terminal is activated—based on the MIME type information—such that the parameter data are used to activate and/or change and/or deactivate the communication profile in the telecommunication terminal by virtue of the MIME handler application having at least partial access to the eUICC module and bringing about a change and/or addition to the content of the memory area associated with the eUICC module.

According to the invention, this advantageously allows cryptographically secured, authenticated and authorized operations to be requested on an Internet terminal or telecommunication terminal (terminal) by an operator (or network operator of the telecommunication network) when the telecommunication terminal has set up a communication session with an operator system (i.e. a server device of the network operator, that is to say ultimately of the telecommunication network). This will probably become necessary in the future when using embedded subscriber identity modules (eSIMs) or embedded universal integrated circuit cards (eUICCs) in eUICC modules—particularly when these are used for the end customer mass market (consumer segment), because this gives rise to customer processes in which eSIM-specific (or eUICC-specific operations—such as the provisioning of an eSIM profile—are handled in the course of a dialog between the end customer and the mobile radio operator (or the network operator of the telecommunication network) using the relevant terminal of the customer (or telecommunication terminal).

Exemplary embodiments of a method according to the invention allow available system functions of the telecommunication terminal to be taken as a basis for initiating an operation on the terminal or the telecommunication terminal without a specific application being needed. In this context, the term “available system functions” is intended to be understood to mean such functions or executable tools as are available per se on an Internet-compatible terminal or a smartphone or a tablet computer. The function call can be transported to the terminal or telecommunication terminal using an application protocol. In this case, the “dispatching” or the actual execution of the function call (in the system of the telecommunication terminal) is left, according to the invention, to the processing of different MIME types (Multipurpose Internet Mail Extensions types) by the application platform—for example the operating system.

Exemplary embodiments of a method according to the invention or a system according to the invention or a telecommunication terminal according to the invention may be used in a different manner from the standard use of MIME handlers (i.e. programs or applications or tools for handling particular types of transmitted files, i.e. particular MIME types), which involves media content being reproduced: the method for handling different MIME types is used, according to the invention, to call general operations of the client, i.e. of the telecommunication terminal. In this context, it is in particular probable, according to the invention, that these operational calls will not be immediately perceptible to the user of the terminal or telecommunication terminal. This particularly gives rise to high new demands on the authorization of such a call.

According to the present invention, a method may be implemented so that at least the integrity and the authenticity of the function call are ensured by cryptographic methods. The confidentiality of the function call is supported, according to the invention, particularly on the basis of the use of cryptographic standard methods—in particular symmetric encryption methods (e.g. AES (Advanced Encryption Standard), DES (Data Encryption Standard), Blowfish) and/or asymmetric encryption methods (e.g. RSA (Rivest, Shamir and Adleman cryptosystem), Rabin (Rabin cryptosystem), Elliptic Curve Cryptography (ECC)). These three cited security aspects are used for the method according to the invention in order to ensure a standard method that is not dependent on platform-specific support for MIME handlers, i.e. is not dependent on the platform used or the operating system used on the telecommunication terminal (such as the Android operating system, the iOS operating system, the WindowsPhone operating system, the FirefoxOS operating system or the like, for example).

Based on the established authenticity, it is the task of the MIME handler to authorize the execution of the operation, and the MIME handler complies with the requirements of the user of the terminal.

According to the present invention, there is provision, by way of example, for a request for provision and/or activation and/or deactivation of a communication profile of an eSIM/eUICC to be transmitted by the telecommunication terminal to a server device of the network operator of the telecommunication network. According to the invention, this request can be transmitted wirelessly or by wire, for example, via one or more networks. The request for provision and/or activation and/or deactivation of the communication profile can, according to the invention, include a request for eSIM information, for example.

The communication profile or the plurality of communication profiles can be stored on the telecommunication terminal in a wide variety of ways, for example the eSIM can be stored on an embedded chip card (e.g. an eUICC). Alternatively or cumulatively, the communication profile or the multiple communication profiles can be installed in the device memory and executed via a device processor.

According to the present invention, there is provision for parameter data to be transmitted between a telecommunication network and a telecommunication terminal. The transmission of the parameter data is used, according to the invention, for the activation and/or changing and/or deactivation of a communication profile defined or denoted by the parameter data on the telecommunication terminal. In this context, according to the invention, there is provision, according to an alternative embodiment, for the communication profile not yet to have been available on the telecommunication terminal before the transmission, but rather only after the transmission of the parameter data, that is to say that the parameter data comprise the communication profile, for example in encrypted form. According to a further alternative embodiment of the invention, there may be provision for the communication profile to be already stored on the telecommunication terminal at least partially at a time before the transmission of the parameter data and for there to be merely provision for activation (or changing or deactivation) of the communication profile via the transmission of the parameter data.

According to the invention, the telecommunication terminal has an eUICC module, wherein the eUICC module provides the functions of an embedded universal integrated circuit card (eUICC). The eUICC module is used to store the parameter data—at least partially or indirectly for use of the telecommunication network according to the communication profile—in a memory area associated with the eUICC module. In this case, the communication profile is associated both with a network operator of the telecommunication network and with the telecommunication terminal or with a user of the telecommunication terminal. Without the transmission of the parameter data, the desired type of use of the telecommunication network (that is to say the activation and/or changing of the use and/or the deactivation, for example) according to the communication profile is not possible, for example because the memory map of the memory area associated with the eUICC module is inconsistent with the desired type of use. In this respect, the parameter data are stored at least partially or indirectly for (desired) use of the telecommunication network, which does not imperatively mean that all of the transmission parameter data would need to be stored in the associated memory area in precisely the transmitted form, however.

According to the invention, to transmit the parameter data to the telecommunication terminal and to activate and/or change and/or deactivate the communication profile in the eUICC module of the telecommunication terminal, the following steps are provided:
in a first step, the parameter data are transmitted from the telecommunication network to the telecommunication terminal, wherein the parameter data have an associated piece of MIME type information (Multipurpose Internet Mail Extensions type information),
in a second step, which follows the first step, a MIME handler application of the telecommunication terminal is activated—based on the MIME type information—such that the parameter data are used to activate and/or change and/or deactivate the communication profile in the telecommunication terminal by virtue of the MIME handler application having at least partial or at least indirect access to the eUICC module and bringing about a change and/or addition to the content of the memory area associated with the eUICC module.

As a result, it is advantageously possible, according to the invention, for the transmission of the parameter data to ultimately prompt the MIME handler application to gain at least partial or at least indirect access to the eUICC module. In particular, it is not necessary, according to the invention, for the access to the eUICC module to require installation of a particular application on the telecommunication terminal.

According to the invention, it is preferred for the parameter data of the communication profile to correspond to an operational profile of the eUICC module, wherein the parameter data are particularly profile data.

As a result, it is possible, according to the invention, for a provisional profile (what is known as a provisioning profile) to be already in the memory of the telecommunication terminal when the telecommunication terminal is delivered, for example. In this case, according to one variant, data of the provisional profile can be used in order to be added to, together with data that are transmitted to the telecommunication terminal by the transmission of the parameter data, to form a usable operational profile. According to a further variant, the data that are transmitted to the telecommunication terminal by the transmission of the parameter data are added to independently of the provisional profile to form a usable operational profile. According to the invention, the parameter data may be particularly profile data or else data via which activation or changing or deactivation of communication profiles is performed, which are therefore themselves not part of communication profiles and hence profile data. The concept of the eUICC provides for different eSIM profiles to be rigidly separated from one another. To this end, they are stored in different “security domains”, between which no information is interchanged.

According to the invention, there is further preference for the telecommunication terminal to have not only the MIME handler application but also an application platform or an operating system and a transmission application, the transmission application being used to transmit the parameter data to the telecommunication terminal.

As a result, it is advantageously possible, according to the invention, for the transmission of the parameter data to be realized by a browser application or a downloader application, for example.

It is further preferred, according to the invention, that in the second step, and based on the MIME type information associated with the parameter data, the transmission application is used, and/or the application platform or operating system participates, to activate the MIME handler application to perform an operation with access to the eUICC module in order to activate and/or change and/or deactivate the parameter data.

Therefore, it is advantageously possible, according to the invention, for the transmission of the parameter data to reliably allow the desired activation and/or changing and/or deactivation of the communication profiles.

According to the invention, it is further also preferred for the parameter data to be transmitted from a network node element of the telecommunication network to the telecommunication terminal in the first step.

This advantageously allows, according to the invention, a particular server device as part of the telecommunication network to realize the transmission of the parameter data.

A further subject of the present invention relates to a system for transmitting parameter data between a telecommunication network and a telecommunication terminal and for activating and/or changing and/or deactivating a communication profile defined by the parameter data on the telecommunication terminal, wherein the system comprises the telecommunication network and the telecommunication terminal, wherein the telecommunication terminal has an eUICC module, wherein the eUICC module provides the functions of an embedded universal integrated circuit card (eUICC), wherein the eUICC module is used to store the parameter data at least partially or indirectly for use of the telecommunication network according to the communication profile in a memory area associated with the eUICC module, wherein the communication profile is associated
both with a network operator of the telecommunication network
and with the telecommunication terminal or with a user of the telecommunication terminal,
   wherein the system is configured such that to transmit the parameter data to the telecommunication terminal and to activate and/or change and/or deactivate the communication profile in the eUICC module of the telecommunication terminal:
the parameter data are transmitted from the telecommunication network to the telecommunication terminal, wherein the parameter data have an associated piece of MIME type information (Multipurpose Internet Mail Extensions type information),
a MIME handler application of the telecommunication terminal is activated based on the MIME type information such that the parameter data are used to activate and/or change and/or deactivate the communication profile in the telecommunication terminal by virtue of the MIME handler application having at least partial or at least indirect access to the eUICC module and bringing about a change and/or addition to the content of the memory area associated with the eUICC module.

Such a system can advantageously be used, according to the invention, to perform cryptographically secured, authenticated and authorized operations on a telecommunication terminal, when requested by a network operator of the telecommunication network, in a secure manner.

According to the invention, it is likewise particularly preferred, in regard to the system, for the telecommunication terminal of the system to have not only the MIME handler application but also an application platform or an operating system and a transmission application, wherein the system is configured such that the parameter data are transmitted to the telecommunication terminal using the transmission application.

Further, according to the invention, it is particularly preferred, in regard to the system, for the system to be configured such that based on the MIME type information associated with the parameter data, the transmission application is used, and the application platform or operating system participates, to activate the MIME handler application to perform an operation with access to the eUICC module in order to activate and/or change and/or deactivate the parameter data.

A further subject of the present invention relates to a telecommunication terminal for transmitting parameter data between a telecommunication network and the telecommunication terminal and for activating and/or changing and/or deactivating a communication profile defined by the parameter data on the telecommunication terminal, wherein the telecommunication terminal has an eUICC module, wherein the eUICC module provides the functions of an embedded universal integrated circuit card (eUICC), wherein the eUICC module is used to store the parameter data at least partially or indirectly for use of the telecommunication network according to the communication profile in a memory area associated with the eUICC module, wherein the communication profile is associated
both with a network operator of the telecommunication network
and with the telecommunication terminal or with a user of the telecommunication terminal,
   wherein the telecommunication terminal is configured such that to transmit the parameter data to the telecommunication terminal and to activate and/or change and/or deactivate the communication profile in the eUICC module of the telecommunication terminal:
the parameter data are transmitted from the telecommunication network to the telecommunication terminal, wherein the parameter data have an associated piece of MIME type information (Multipurpose Internet Mail Extensions type information),
a MIME handler application of the telecommunication terminal is activated based on the MIME type information such that the parameter data are used to activate and/or change and/or deactivate the communication profile in the telecommunication terminal by virtue of the MIME handler application having at least partial or at least indirect access to the eUICC module and bringing about a change and/or addition to the content of the memory area associated with the eUICC module.

Such a telecommunication terminal can advantageously be used, according to the invention, to perform cryptographically secured, authenticated and authorized operations on a telecommunication terminal, when requested by a network operator of the telecommunication network, in a secure manner.

According to the invention, it is particularly preferred, in regard to the telecommunication terminal, for the telecommunication terminal to have not only the MIME handler application but also an application platform or an operating system and a transmission application, wherein the telecommunication terminal is configured such that the parameter data are transmitted to the telecommunication terminal using the transmission application.

Further, according to the invention, it is particularly preferred, in regard to the telecommunication terminal, for the telecommunication terminal to be configured such that based on the MIME type information associated with the parameter data, the transmission application is used, and the application platform or operating system participates, to activate the MIME handler application to perform an operation with access to the eUICC module in order to activate and/or change and/or deactivate the parameter data.

Further, the present invention also relates to a computer program having a program code that can be used to perform all the steps of the method according to the invention when the computer program is executed on a programmable device, particularly as part of the system, or on the telecommunication terminal.

In addition, the subject matter of the present invention is a computer program product having a computer-readable medium and a computer program stored on the computer-readable medium with a program code for transmitting parameter data between a telecommunication network and a telecommunication terminal and for activating and/or changing and/or deactivating a communication profile defined by the parameter data on the telecommunication terminal, which are suitable for allowing all the steps of the method according to the invention to be performed when the computer program is executed on a programmable device, particularly as part of the telecommunication network, or on the telecommunication terminal.

Further details, features and advantages of the invention will emerge from the drawings and from the description of preferred embodiments on the basis of the drawings that follows. In this case, the drawings illustrate merely exemplary embodiments of the invention that do not limit the invention.

The present invention is described with reference to particular embodiments and with reference to the accompanying drawings, the invention not being restricted to these embodiments and to these drawings, however, but rather being determined by the patent claims. The drawings are not restrictive. Particular elements in the drawings may be depicted in enlarged or exaggerated form and not to scale for the purposes of depiction.

Unless specifically indicated otherwise, the use of an indefinite or definite article with reference to a word in the singular, for example “a” or “the”, also comprises the plural of such a word. The designations “first”, “second” and so on in the description and in the claims are used to distinguish between similar elements or like elements that need to be distinguished and not necessarily to describe a temporal or other sequence. The terms used as such can fundamentally be regarded as interchangeable under applicable conditions.

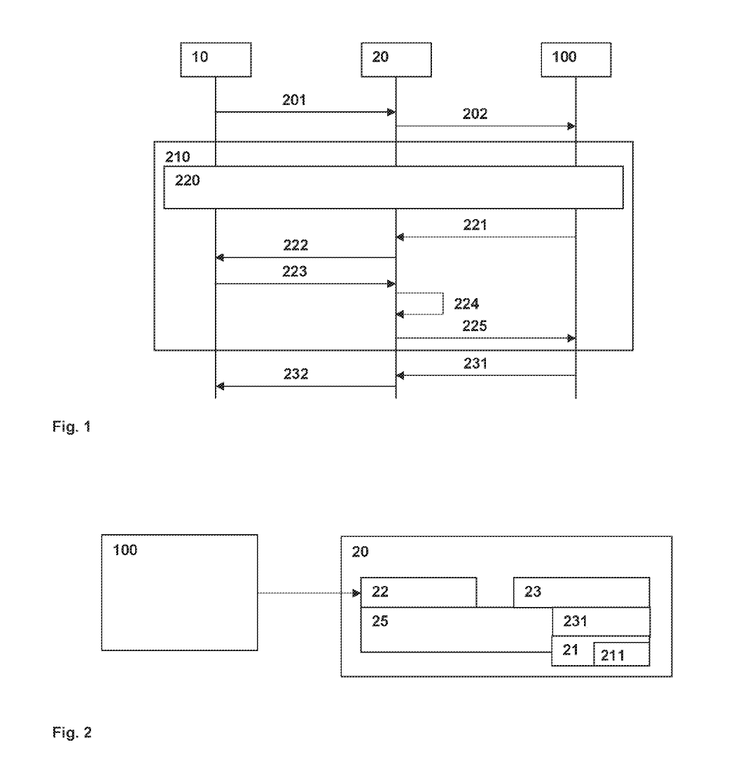

FIG. 1 schematically depicts a communication diagram between a user 10 of a telecommunication terminal, the telecommunication terminal 20 and the telecommunication network 100 according to an exemplary embodiment of the invention.

During a first process step 201, the user 10 decides to start an interaction with the telecommunication terminal 20 for the purpose of making contact with the network operator or operator of the telecommunication network 100. In a second process step 202, a connection from the telecommunication terminal 20 is made to the network operator or operator of the telecommunication network 100. This is followed during a third process step 220 by a customer interaction by the user, via the telecommunication terminal 20, with the network operator of the telecommunication network 100. In a fourth process step 221, the network operator of the telecommunication network 100, i.e. the telecommunication network 100, initiates an eSIM operation on the telecommunication terminal 20. In a fifth process step 222, the user 10 is normally, but not necessarily, made aware of this, in particular has it displayed to him or bought to his attention in another way. In a sixth process step 223, performance of the eSIM operation initiated in the fourth process step 221 is—likewise normally, but not necessarily—confirmed and authorized by the user 10. In a seventh process step 224, the eSIM operation initiated in the fourth process step 221 is performed, and in an eighth process step 225, it is transmitted to the network operator of the telecommunication network 100. In a ninth process step 231, the process of interaction for the purpose of making contact with the network operator or operator of the telecommunication network 100 that is initiated in the first process step 201 is completed, and in a tenth process step 232, the user ends the visit or the process of interaction with the telecommunication network 100. The process steps between the third process step 220 and the eighth process step 225 inclusive are depicted in combination in FIG. 1 and provided with the reference symbol 210 in order to indicate that these process steps can also be performed repeatedly during the initiated process of interaction for the purpose of making contact with the network operator or operator of the telecommunication network 100, but normally with a respective different eSIM operation initiated by the respective fourth process step 221 and performed by the respective seventh process step 224.

FIG. 2 schematically depicts a part (or a network node) of the telecommunication network 100 and a telecommunication terminal 20 according to the invention. The telecommunication terminal 20 has an eUICC module 21, a memory area 211 associated with the eUICC module 21, a transmission application 22 and a MIME handler application 23. Schematically, an operation 231, particularly in the form of an eSIM operation 231, is schematically depicted, the eSIM operation 231 operating on the eUICC module 21 and causing a change to the memory map of the memory area 211 associated with the eUICC module 21. Further, the telecommunication terminal 20 has an application platform 25 or an operating system 25.

According to the invention, in a first step, the parameter data are transmitted from the telecommunication network 100 to the telecommunication terminal 20 via the transmission application 22. In this case, the parameter data have an associated piece of MIME type information (Multipurpose Internet Mail Extensions type information)

In a second step, which follows the first step, the MIME handler application 23 of the telecommunication terminal 20 is activated—based on the MIME type information—for example, but not necessarily, via the application platform or operating system 25 such that the parameter data are used to activate and/or change and/or deactivate the communication profile in the telecommunication terminal 20, in which case the MIME handler application 23 has at least partial or at least indirect access to the eUICC module 21 and brings about a change and/or addition to the content of the memory area 211 associated with the eUICC module 21. According to the invention, the parameter data are a serialized function call, i.e. in the sense of a serialization or of marshalling (i.e. mapping of structured data onto a sequential form of depiction).

For the performance of an exemplary embodiment of the method according to the invention (and accordingly for the system according to the invention and the telecommunication terminal according to the invention), it is irrelevant which application and which protocol is used to load the serialized function call onto the client (i.e. the telecommunication terminal 20). In the context of the present invention, the transmission application 22 is also referred to as a “downloader” and is provided particularly in the form of a browser or a browser device. According to the invention, the transmission application 22 or the downloader merely demands that it determines the MIME type of the downloaded content, i.e. of the parameter data, and starts the configured MIME handler application 23 of the ascertained MIME type for the downloaded content. In principle, this behavior is realized for a number of standard applications, particularly web browsers or browser applications, but this behavior is conventionally not used for accessing the eUICC module 21 inside a telecommunication terminal 20.

According to the invention, a MIME type is stipulated for the MIME handler application 23 that is to be called. This MIME type is used to configure the telecommunication terminal 20 once by virtue of a MIME handler application 23 specific to the method being recorded on the respective execution platform of the respective telecommunication terminals 20. These configuration methods are platform-specific (for example for the Android operating system, the WindowsPhone operating system, the Windows operating system, the iOS operating system, etc.). A server device that provides content for such a MIME type is intended—provided that it is supported by the application protocol—to signal the MIME type when downloading associated content, for example via the advice “HTTP Header Content Type”.

After the download, i.e. the transmission of the parameter data to the telecommunication terminal 20, the transmission application starts the recorded MIME handler application 23 for the ascertained MIME type. The MIME handler application 23 verifies the downloaded content in regard to integrity and authenticity. If this has been able to be performed successfully, the MIME handler application 23 authorizes the authenticated originator of the content. Only after successful authorization
are the operations to be called ascertained from the downloaded content,
are the parameters of the operation to be called deserialized,
is, optionally, the response address to which the result of the operation is sent deserialized,
is the operation called with the prescribed parameters,
is, depending on whether or not the response address is available, the result of the operation or else just a piece of information about the success or error result, or error message, of said operation serialized.

The serialization format used and the cited steps are, according to the invention, in particular specific to the MIME handler application 23 used. If a response address has been transmitted, the serialized result is again cryptographically secured in regard to integrity and authenticity of the client, i.e. of the telecommunication terminal 20,—possibly also in regard to confidentiality—and transmitted to the response address.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: A method for transmitting parameter data between a telecommunication network and a telecommunication terminal and for activating and/or changing and/or deactivating a communication profile defined or denoted by the parameter data on the telecommunication terminal, wherein the telecommunication terminal has an embedded universal integrated circuit card (eUICC) module, wherein the eUICC module provides the functions of an eUICC, wherein the eUICC module is used to store the parameter data at least partially or indirectly for use of the telecommunication network according to the communication profile in a memory area associated with the eUICC module, wherein the communication profile is associated both with a network operator of the telecommunication network and with the telecommunication terminal or a user of the telecommunication terminal, wherein the method comprises:
in a first step, receiving, by the telecommunication terminal, the parameter data from the telecommunication network, wherein the parameter data have an associated piece of Multipurpose Internet Mail Extensions (MIME) type information; and
in a second step, which follows the first step, activating a MIME handler application of the telecommunication terminal—based on the MIME type information—such that the parameter data are used to activate and/or change and/or deactivate the communication profile in the telecommunication terminal by virtue of the MIME handler application having at least partial or at least indirect access to the eUICC module and bringing about a change and/or addition to the content of the memory area associated with the eUICC module.

2: The method according to claim 1, wherein the parameter data of the communication profile correspond to an operational profile of the eUICC module, wherein the parameter data are profile data.

3: The method according to claim 1, wherein the telecommunication terminal further comprises an application platform and a transmission application, wherein the transmission application is used to transmit the parameter data to the telecommunication terminal.

4: The method according to claim 3, wherein in the second step, and based on the MIME type information associated with the parameter data, the transmission application is used, and/or the application platform participates, to activate the MIME handler application to perform an operation with access to the eUICC module in order to activate and/or change and/or deactivate the parameter data.

5: The method according to claim 1, wherein the parameter data are transmitted from a network node element of the telecommunication network to the telecommunication terminal in the first step.

6: A system for transmitting parameter data between a telecommunication network and a telecommunication terminal and for activating and/or changing and/or deactivating a communication profile defined by the parameter data on the telecommunication terminal, wherein the system comprises:
the telecommunication network; and
the telecommunication terminal;
wherein the telecommunication terminal has an embedded universal integrated circuit card (eUICC) module, wherein the eUICC module is configured to provide the functions of an eUICC, wherein the eUICC module is configured to store the parameter data at least partially or indirectly for use of the telecommunication network according to the communication profile in a memory area associated with the eUICC module, wherein the communication profile is associated both with a network operator of the telecommunication network and with the telecommunication terminal or a user of the telecommunication terminal;
wherein the telecommunication network is configured to transmit the parameter data to the telecommunication terminal, wherein the parameter data have an associated piece of Multipurpose Internet Mail Extensions (MIME) type information; and
wherein a MIME handler application of the telecommunication terminal is configured to be activated based on the MIME type information such that the parameter data are used to activate and/or change and/or deactivate the communication profile in the telecommunication terminal by virtue of the MIME handler application having at least partial or at least indirect access to the eUICC module and bringing about a change and/or addition to the content of the memory area associated with the eUICC module.

7: The system according to claim 6, wherein the telecommunication terminal further comprises an application platform and a transmission application, and wherein the telecommunication terminal is further configured to transmit the parameter data using the transmission application.

8: The system according to claim 7, wherein the transmission application is configured to be used, and the application platform is configured to participate, based on the MIME type information associated with the parameter data, to activate the MIME handler application to perform an operation with access to the eUICC module in order to activate and/or change and/or deactivate the parameter data.

9: A telecommunication terminal for transmitting parameter data between a telecommunication network and the telecommunication terminal and for activating and/or changing and/or deactivating a communication profile defined by the parameter data on the telecommunication terminal, wherein the telecommunication terminal has an embedded universal integrated circuit card (eUICC) module, wherein the eUICC module is configured to provide the functions of an eUICC, wherein the eUICC module is configured to store the parameter data at least partially or indirectly for use of the telecommunication network according to the communication profile in a memory area associated with the eUICC module, wherein the communication profile is associated both with a network operator of the telecommunication network and with the telecommunication terminal or a user of the telecommunication terminal, wherein the telecommunication terminal comprises a processor and a memory having processor-executable instructions stored thereon, wherein the processor is configured to execute the processor-executable instructions to facilitate:
receiving the parameter data from the telecommunication network, wherein the parameter data have an associated piece of Multipurpose Internet Mail Extensions (MIME) type information; and
activating a MIME handler application of the telecommunication terminal based on the MIME type information such that the parameter data are used to activate and/or change and/or deactivate the communication profile in the telecommunication terminal by virtue of the MIME handler application having at least partial or at least indirect access to the eUICC module and bringing about a change and/or addition to the content of the memory area associated with the eUICC module.

10: The telecommunication terminal according to claim 9, wherein the telecommunication terminal further comprises an application platform and a transmission application, wherein the transmission application is configured to receive the parameter data.

11: The telecommunication terminal according to claim 10, wherein the transmission application is configured to be used, and the application platform is configured to participate, based on the MIME type information associated with the parameter data, to activate the MIME handler application to perform an operation with access to the eUICC module in order to activate and/or change and/or deactivate the parameter data.

12-13. (canceled)

14: A non-transitory, computer-readable medium having processor-executable instructions stored thereon for transmitting parameter data between a telecommunication network and a telecommunication terminal and for activating and/or changing and/or deactivating a communication profile defined or denoted by the parameter data on the telecommunication terminal, wherein the telecommunication terminal has an embedded universal integrated circuit card (eUICC) module, wherein the eUICC module provides the functions of an eUICC, wherein the eUICC module is used to store the parameter data at least partially or indirectly for use of the telecommunication network according to the communication profile in a memory area associated with the eUICC module, wherein the communication profile is associated both with a network operator of the telecommunication network and with the telecommunication terminal or a user of the telecommunication terminal, wherein the processor-executable instructions, when executed, facilitate performance of the following:
in a first step, receiving, by the telecommunication terminal, the parameter data from the telecommunication network, wherein the parameter data have an associated piece of Multipurpose Internet Mail Extensions (MIME) type information; and
in a second step, which follows the first step, activating a MIME handler application of the telecommunication terminal—based on the MIME type information—such that the parameter data are used to activate and/or change and/or deactivate the communication profile in the telecommunication terminal by virtue of the MIME handler application having at least partial or at least indirect access to the eUICC module and bringing about a change and/or addition to the content of the memory area associated with the eUICC module.
